(19) United States
(12) Patent Application Publication
(10) Pub. No.: US 2009/0194692 A1
(43) Pub. Date: Aug. 6, 2009

(54) CHARGED PARTICLE RADIATION APPARATUS

(76) Inventor: Atsushi KOBARU, Hitachinaka (JP)

Correspondence Address: MCDERMOTT WILL & EMERY LLP, 600 13TH STREET, N.W., WASHINGTON, DC, 20005-3096, US

(21) Appl. No.: 12/362,000

(22) Filed: Jan. 29, 2009

(30) Foreign Application Priority Data
Jan. 31, 2008 (JP) 2008-020041

(51) Int. Cl. G01N 23/00; G21F 3/00; H01J 3/14

(52) U.S. Cl. 250/311; 250/515.1; 250/396 R

(57) ABSTRACT

A magnetic shield with which a high magnetic field suppression effect is realized in a restricted space and a charged particle radiation apparatus using the magnetic shield are described below. To achieve the above-described object, a scanning electron microscope wherein a shield for shielding against an external magnetic field is formed of a plurality of plate portions made of a magnetic material, the plate portions being disposed on the circumference of a circle whose center corresponds to a center of the space so that each plate portion has a surface direction set different from a line tangent to the circle, is proposed (see FIG. 1).

### BACKGROUND OF THE INVENTION

1. Field of the Invention

The present invention relates to a charged particle radiation apparatus or the like, i.e., an apparatus for observing or measuring, for example, the shape or the material of a specimen to be observed by applying an electron beam to the specimen and by utilizing a physical phenomenon such as generation of secondary electrons obtained from the specimen.

2. Background Art

In scanning electron microscopes, which are one of kinds of charged particle radiation apparatus, bending of an electron beam during scanning and a deformation or disturbance in a resulting image occur frequently under the influence of a magnetic field externally generated and flowing in.

According to JP Patent Publication (Kokai) No. 2004-014909A or JP Patent Publication (Kokai) No. 2-278642 A (1995) for example, a technique to solve such a problem by covering the periphery of a scanning electron microscope with a magnetic shield has been proposed. A method of bending a flat sheet of ferromagnetic magnetic material into a simple cylinder and covering the periphery of a scanning electron microscope with the cylinder to limit the influence of a magnetic field has also been practiced.

Also, a method of multiply, for example, doubly or triply wrapping cylindrical shields to improve the magnetic field suppression effect in the case of using the above-described shield or the like has been practiced.

### SUMMARY OF THE INVENTION

A shield formed as a multiple type for the purpose of improving the magnetic field suppression effect necessitates a correspondingly increased space. In particular, an attempt to further improve the magnetic field suppression effect entails an increase in thickness of the shield surrounding the apparatus, and the practicability of such an attempt is thought to be considerably low from consideration of mounting and cost performance.

A magnetic shield with which a high magnetic field suppression effect is realized in a restricted space and an apparatus using the magnetic shield, particularly a charged particle radiation apparatus are described below.

To achieve the above-described object, an apparatus wherein a shield for shielding against an external magnetic field is formed of a plurality of plate portions made of a magnetic material, the plate portions being disposed on the circumference of a circle whose center corresponds to a center of the space so that each plate portion has a surface direction set different from a line tangent to the circle, is proposed.

In one form of the apparatus, the outer periphery of the tubular shield is covered with a ferromagnetic material plate bent into a triangular wave form. The new shield in triangular form is characterized by having a slanting surface having a mount angle not equal to 0° from the direction of line tangent to the tubular shielding surface, as shown in FIG. 2. By the effect of the new shield, a shield having an improved magnetic field suppression effect is realized in a considerably small mount space.

The above-described shield is capable of reducing the influence of an externally generated magnetic field on an apparatus such as a scanning electron microscope.

### BRIEF DESCRIPTION OF THE DRAWINGS

FIG. 1 is a diagram illustrating an example of a magnetic field having a plurality of slanting plate portions.

FIG. 2 is an enlarged view of a portion of the magnetic field shown in FIG. 1.

FIG. 3 is a diagram schematically showing an electron microscope.

FIG. 4 is a diagram for explaining the influence of an external magnetic field on an electron microscope image.

FIG. 5 is a diagram showing another form of the magnetic field.

FIG. 6 is a diagram showing still another form of the magnetic field.

FIG. 7 is a diagram showing s further form of the magnetic field.

### DESCRIPTION OF SYMBOLS

1 Electron beam
2 Primary electron beam
3 First converging lens
4 Second converging lens
5 Deflector
6 Objective lens
7 Specimen
8 First converging lens power supply
9 Second converging lens power supply
10 Deflector driver
11 Deflection signal generator
12 Secondary electron detector
13 Amplifier
14 Objective lens power supply
15 Controller

### DETAILED DESCRIPTION OF THE PREFERRED EMBODIMENTS

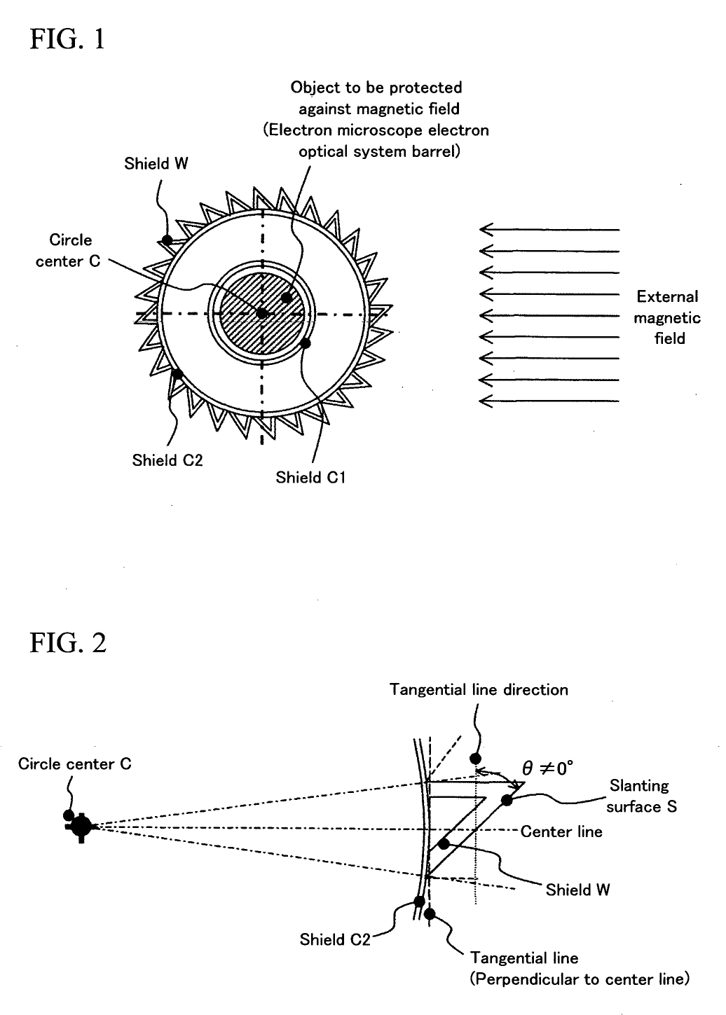

One form of a magnetic shield will be described with reference to the drawings. FIG. 1 is a diagram illustrating an example of a magnetic shield having a plurality of slanted plate portions. FIG. 1 shows an embodiment of the present invention.

In the example shown in FIG. 1, a double shield formed of a shield C1 and a shield C2 in order from an inner position is provided around an object to be protected against a magnetic field (an electron microscope electron optical system barrel), and a shield W bent into a triangular wave shape is further provided outside the double shield. A basic magnetic field suppression effect can be obtained by means of the double shield formed of the shield C1 and the shield C2. The shield W in triangular wave form, which is a feature of the present invention, is further provided in an outer position to largely reduce an external magnetic field reaching the electron microscope electron optical system barrel (column).

FIG. 2 is an enlarged diagram of a portion of the magnetic shield. In FIG. 2, one-wave portion of the shield W in triangular wave form is shown in an enlarged state. The shield shown in FIG. 2 has on the outside of the shield C2 the shield W having a slanting surface S with an arbitrary angle not equal to 0° from the direction of a tangential line substantially perpendicular to a center line extending to the surface of the shield C2 from a cycle center C at a center of the object to be protected against a magnetic field (the electron microscope electron optical system barrel).

In the example shown in FIG. 2, plate portions (slanting surfaces S) constituting the shield are formed so as to be slant with respect to a straight line connecting the column center and an external magnetic field generation source. In other words, the plate portions are disposed at an angle (θ) other than 0° from lines tangent to the outer periphery of the cylindrical column.

With the arrangement in which the plurality of plate portions having surfaces parallel to the optical axis of an electron beam (the ideal optical axis when the electron beam is not deflected) are disposed along the cylindrical body (the column of the electron microscope and the shield surrounding the column) and one of opposite sides of each plate portion is set away from the optical axis relative to the other side, the magnetic field suppression effect can be improved on a straight line connecting the locus of passage of the electron beam and the external magnetic field generation source. One of the effects of the arrangement is that the shield W has a thickness of W=(W1/cos θ) (W1 is the thickness in the direction perpendicular to the surface direction of the shield W). That is, the shield can be made substantially thicker in comparison with the case where a shielding member in plate form is simply disposed around the column. Another of the effects is that magnetic lines to be suppressed are prevented from entering perpendicularly to the surface of the shield W.

Also, since the shielding member itself is provided in a monocoque construction by bending a magnetic member into a triangular shape, the shield can be easily installed with an appropriate space between the shield W and the shield C2 being provided, only by wrapping the member around a cylindrical shielding member without requiring any special supporting member or the like.

A structure such as that of the shield W is particularly effective in application to an electron beam barrel which is made cylindrical in principle. For example, if a triangular shielding member is applied to shielding around a body in box form such as a cubic or rectangular body, the value of W1 varies largely depending on the position of an external magnetic field generation source. In some region, the thickness of the shield W is substantially the same as W1 as seen from the center of the body in box form. In such a case, therefore, the desired magnetic field suppression effect cannot be expected, in contrast with the case where a plate member is omnidirectionally applied to a cylindrical body. In the case of application to a cylindrical body, the effect of suppressing magnetic fields in all directions with stability can be expected. Further, since the shield W is of such a construction that it projects from the shield C2, the effect of suppressing reaching of magnetic fields to the column can be improved.

In the present embodiment, a plate member having the shape of a right-angled triangle as seen along the direction irradiation of the electron beam is adopted. However, such a plate member is not exclusively used. For example, a plate member having the shape of an equilateral triangle may alternatively be used.

The shielding member may be constructed so as to cover the entire column or may be selectively applied to a portion where the influence of an external magnetic field is particularly considerable.

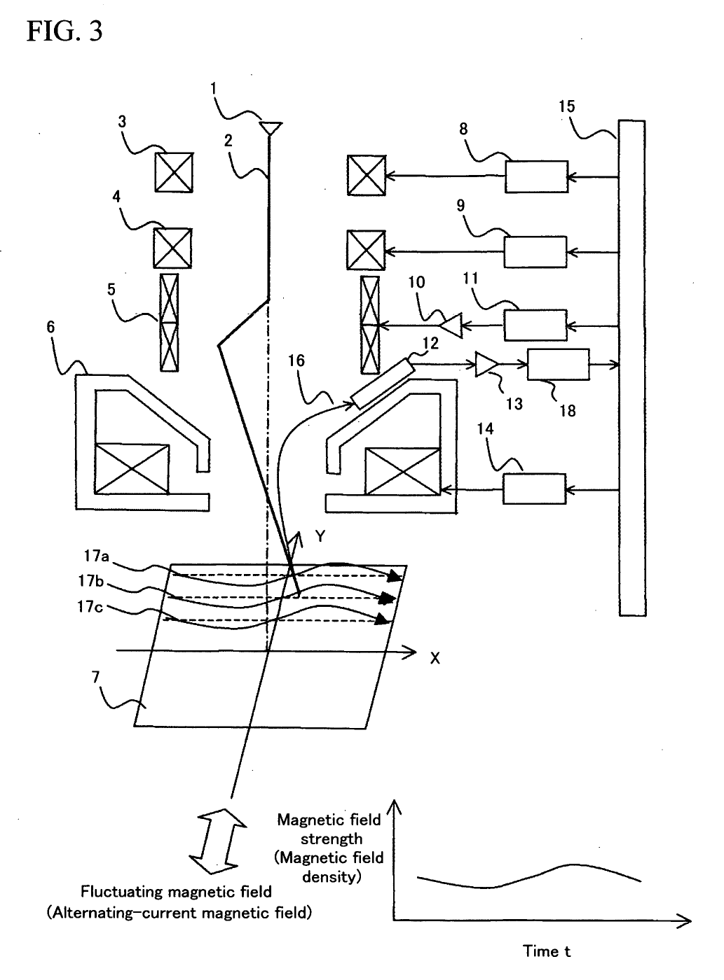

FIG. 3 shows an electron microscope having a magnetic shield such as that described above. Descriptions about this are as follows. The electron microscope shown in FIG. 3 is constituted by an electron beam source 1, a first converging lens 3 and a second converging lens 4 for converging a primary electron beam 2 emitted from the electron beam source 1, a deflector 5 which deflects the primary electron beam 2 for scanning of a surface of a specimen 7 with the primary electron beam 2, an objective lens 6 for focusing the primary electron beam 2 on the specimen 7 surface, a secondary electron detector 12 which detects secondary electrons 16 generated after impingement of the primary electron beam 2 against the specimen 7 surface, a first converging lens power supply 8 and a second converging lens power supply 9 for driving the first converging lens 3 and the second converging lens 4, a deflection signal generator 11 which generates a deflection signal to scan the specimen 7 surface with the primary electron beam 2 by a predetermined method, a deflector driver 10 which drives the deflector 5 by receiving the deflection signal, an amplifier 13 which amplifies a secondary electron signal detected by the secondary electron detector 12, an objective lens power supply 14 for driving the objective lens 6 so that the primary electron beam 2 is focused on a predetermined position, and a controller 15 which controls the above-described components.

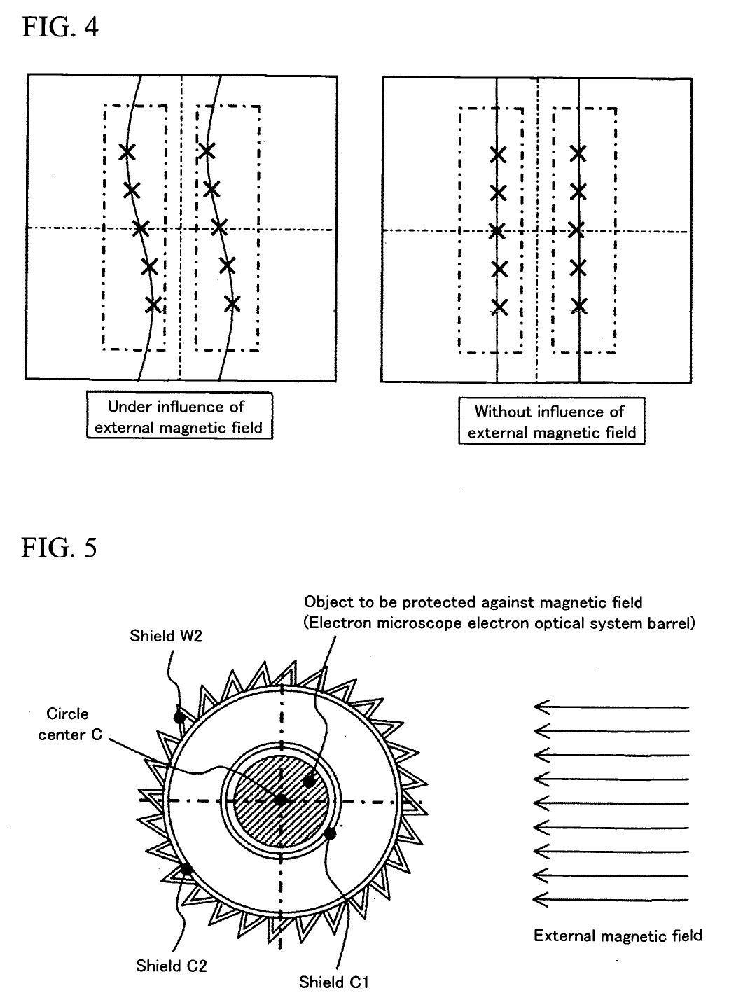

When a magnetic field generated on the outside changes with time on the periphery of the objective lens 6 and the specimen 7, the position at which the primary electron beam 2 reaches the specimen 7 surface is thereby influenced to change along the Y-direction according to the wave of the change of the magnetic field. When this change is in synchronization with the scanning signal for example, a first scanning line 17a, a subsequent scanning line 17b and another subsequent scanning line 17c undulate in conformity with substantially the same waveform. In a resulting SEM image, a line pattern to be seen in straight form undulates in wave form, as shown in FIG. 4, and it is difficult to perform observation through the correct configuration.

In actuality, in many scanning electron microscopes, the scanning signal is synchronized with the period of an alternating-current power supply and is synchronized with power supply noise generated in a different unit operated by the same power supply on the periphery of the microscope. In such a case, the microscope is easily influenced by the power supply noise.

While the present embodiment is described as a scanning electron microscope in one form of a charged particle radiation apparatus by way of example, the present invention is not limited to the described microscope. For example, the present invention can be applied to other charged particle radiation apparatuses including focused ion beam (FIB) apparatuses. However, the electron beam is more susceptible to a magnetic field than the ion beam used in FIB apparatuses. For this characteristic reason, the present invention can be applied to electron microscope with high technical advantages.

FIG. 5 shows another embodiment of the magnetic shield. The orientation of the triangular shape of the shield W is opposite to that in the embodiment shown in FIG. 1 with respect the rotational direction. However, the same magnetic field resistant effect can be obtained.

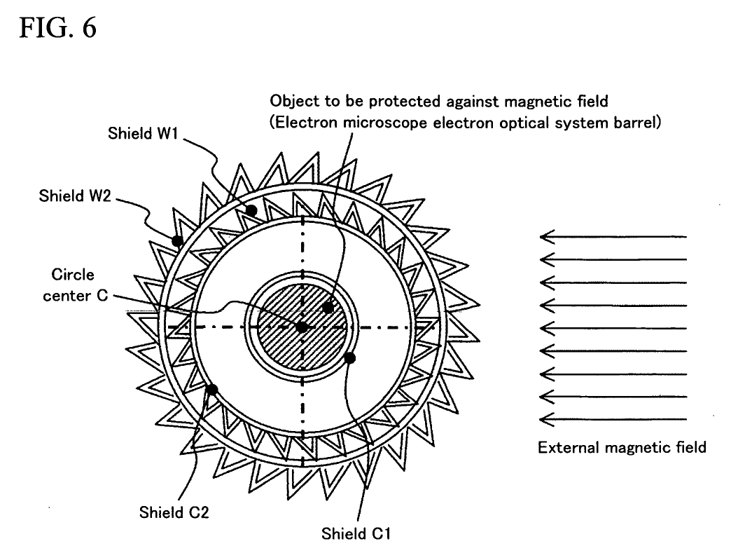

FIG. 6 shows an arrangement meeting a demand for further improving the magnetic field resistance. Covering with a shield W2 shown in FIG. 5 is provided outside the shield W1 shown in FIG. 1 to improve the effect.

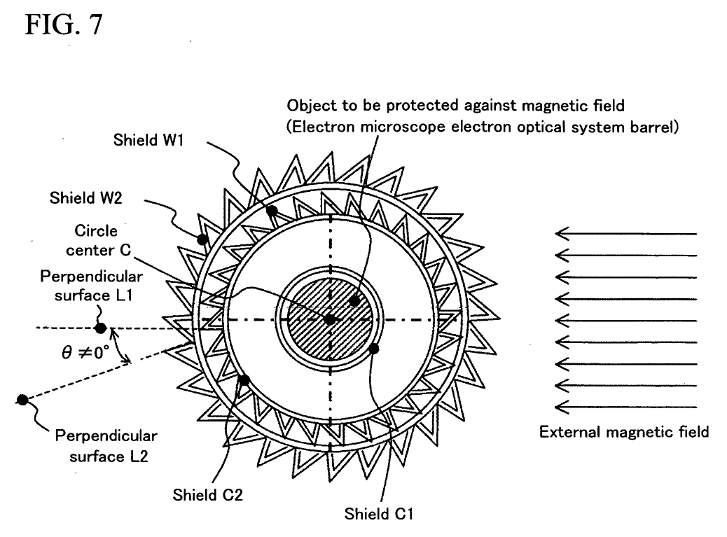

FIG. 7 shows an arrangement meeting a demand for further improving the magnetic field resistance from that of the arrangement shown in FIG. 6. An arbitrary angle not equal to 0° is provided between a perpendicular surface L1 constituting the shield W1 and a perpendicular surface L2 constituting the shield W2 when a mount angle is determined between the shield W1 and the shield W2 shown in FIG. 6. This arrangement enables effectively improving the magnetic field resistance. In the example of the arrangement shown in FIG. 7, the triangular shape of the shield W1 is placed so that a complement to portions at which W1>W is made with the shield W2, thus making possible a much higher shielding effect.

What is claimed is:

1. An apparatus comprising a shield for reducing the influence of a magnetic field flowing from the outside into a predetermined space,
wherein the shield has a plurality of plate portions made of a magnetic material, the plate portions being disposed on the circumference of a circle whose center corresponds to a center of the space so that each plate portion has a surface direction set different from a line tangent to the circle.

2. The apparatus according to claim 1, further comprising at least one inner shield in plate form concentric to the circle.

3. A charged particle radiation apparatus comprising the shield according to claim 1.

4. A charged particle radiation apparatus comprising the shield according to claim 2.

5. A charged particle radiation apparatus comprising a charged particle radiation optical system in which a charged particle beam emitted from a charged particle source is converged and applied to a specimen, and a tubular member surrounding the charged particle radiation optical system,
wherein a magnetic shield having a plurality of plate portions having surfaces parallel to the optical axis of the charged particle beam is provided around the tubular member, and one of opposite sides of each plate portion is formed by being set away from the optical axis relative to the other of the opposite sides.

6. The charged particle radiation apparatus according to claim 5, wherein the magnetic shield has a triangular member having the plate portion as its one side as seen along the optical axis of the charged particle beam.

7. The charged particle radiation apparatus according to claim 5, wherein a plurality of layers of the magnetic shield are formed about the optical axis of the charged particle beam.

8. The charged particle radiation apparatus according to claim 5, wherein the plurality of plate portions are formed of a magnetic material.

9. The charged particle radiation apparatus according to claim 8, wherein the tubular member is formed of a magnetic material.
